(19) United States
(12) Patent Application Publication
(10) Pub. No.: US 2011/0054706 A1
(43) Pub. Date: Mar. 3, 2011

(54) KITCHEN GUN SYSTEM

(76) Inventor: Gerard J. Murphy, Portchester, NY (US)

(21) Appl. No.: 12/874,565

(22) Filed: Sep. 2, 2010

Related U.S. Application Data
(60) Provisional application No. 61/275,738, filed on Sep. 2, 2009.
(60) Provisional application No. 61/298,274, filed on Jan. 26, 2010.

(51) Int. Cl. G05D 7/00; B67D 7/72; B67D 7/74

(52) U.S. Cl. 700/283; 222/135; 222/145.5

(57) ABSTRACT

A kitchen gun system for dispensing edible liquid ingredients as required for cooking. The kitchen gun system includes a plurality of pumps, each having an inlet and an outlet. Packages of edible liquid ingredients are attached to the inlets of the pumps. The outlets of the pumps are connected to a plurality of manifold inputs of a manifold. A plurality of manifold outputs is connected to a hand-held dispensing gun. The dispensing gun has a plurality of control mechanisms corresponding to at least the plurality of inputs on the manifold. Selected edible liquid ingredients may be selectively dispensed from the dispensing gun when desired by operating the respective control mechanisms on the dispensing gun. The kitchen gun system is suitable for use in a kitchen in a commercial establishment and includes sources of highly concentrated liquid precursor for stock, cooking oils and wines, lemon juice, and other liquids. These liquids are pumped to a hand-held gun and, if necessary, mixed with water in a desired concentration while being dispensed as required.

### CROSS REFERENCE TO RELATED APPLICATIONS

This application claims the benefit of U.S. Provisional Application Ser. No. 61/275,738, filed Sep. 2, 2009, and of U.S. Provisional Application Ser. No. 61/298,274, filed Jan. 26, 2010.

### BACKGROUND OF THE INVENTION

1. Field of the Invention

The present invention relates to cooking in a commercial establishment, such as a restaurant, where a large number of meals are prepared on a daily basis. More specifically, the present invention relates to the provision of stocks, cooking oils and wines, and the like to a chef for use during the preparation of meals in a commercial setting.

2. Description of the Prior Art

Traditionally, it took a chef or cook an average of twenty hours to make a stock, the liquid ingredient used to make soup and sauces, by cooking raw ingredients until the entire flavor is changed into a liquid base. When the cooking was completed, the liquid base must be chilled immediately to inhibit the growth of bacteria. This is done by putting the hot liquid into small five-gallon containers, and by placing them in an ice bath. Once chilled, the stock is then refrigerated.

Today, food manufacturers have good quality bases which are used by most fast food and many fine dining establishments. The base is usually sold in one-pound bars which are dissolved and cooked in water to create stock for use in soups and sauces.

Once stock is made from the solid base, small plastic containers and bottles are used to get the stock from large kettles, where it is held, for use on the kitchen cook line. The plastic containers have no portion control, that is, they do not give exact measured amounts of stock; they must be cleaned and washed on a regular basis; they must be filled and refilled repeatedly; and they take up space on the kitchen cook line. Much of the stock in these bottles and containers eventually is discarded at the end of the day for sanitary reasons.

Not only are there bottles of stock on the kitchen cook line, but there are also bottles of cooking oil, cooking wine, lemon juice and other liquids. All of these bottles take up space, need to be replenished and cleaned repeatedly, and lead to waste and unsanitary conditions.

Thus, there is a long-felt need for a way by which these liquids can be provided to a chef on a kitchen cook line without the use of bottles and containers, as heretofore has been necessary. That need is met by the present invention.

### SUMMARY OF THE INVENTION

The invention is generally directed to a dispensing system for dispensing edible liquid ingredients as required in a commercial kitchen environment. The dispensing system includes a compressor for supplying compressed air to a plurality of air-driven pumps, which are powered by the compressed air. Each air-driven pump has an inlet and an outlet. Packages of edible liquid ingredients are separately attached to the inlets of the air-driven pumps. A manifold has a plurality of manifold inputs connected to the outlets of the plurality of air-driven pump. A dispenser is connected to the manifold outputs and has a plurality of control mechanisms corresponding to at least the plurality of inputs on the manifold. Through the operation of the control mechanisms selected edible liquid ingredients may be selectively dispensed from the dispenser.

The invention is also generally directed to a dispensing system for dispensing edible liquid ingredients. A plurality of pumps have inlets attached to packages of an edible liquid ingredient outlets to a plurality of inputs to a manifold for a dispenser. The manifold has a plurality of manifold outputs connected to a dispenser. The dispenser has a plurality of control mechanisms corresponding to at least the plurality of inputs on the manifold. Selected edible liquid ingredients may be selectively dispensed from the dispenser when desired by operating the respective control mechanisms on the dispenser.

The invention is also generally directed to a kitchen gun system for dispensing edible liquid ingredients as required for cooking. The kitchen gun system includes a plurality of pumps, each having an inlet and an outlet. Packages of edible liquid ingredients are attached to the inlets of the pumps. The outlets of the pumps are connected to a plurality of manifold inputs of a manifold. A plurality of manifold outputs is connected to a hand-held dispensing gun. The dispensing gun has a plurality of control mechanisms corresponding to at least the plurality of inputs on the manifold. Selected edible liquid ingredients may be selectively dispensed from the dispensing gun when desired by operating the respective control mechanisms on the dispensing gun.

Accordingly, the present invention is a kitchen gun system by which liquids used in cooking may be dispensed in desired amounts by chefs and cooks in a kitchen in their work areas.

Accordingly it is a further object of the invention to provide a way by which a highly concentrated liquid precursor of a stock of the variety used to prepare soups, sauces and the like in kitchens in commercial establishments may be mixed with water in a preselected concentration while being dispensed for use by cooks and chefs.

Yet another object of the invention is to provide a way by which liquids required in the preparation of food, but not requiring mixing with water, may be dispensed by a chef or cook at the push of a button without requiring the use of numerous bottles and other containers.

Still another object of the present invention to provide cooks and chefs on a kitchen cook line with various liquids that are needed for the preparation of meals without the use of bottles and other containers.

Another object of the invention to provide cooks and chefs with these liquids on a kitchen cook line at the push of a button from a convenient hand-held device.

Yet still another object of the invention to enable cooks and chefs to mix these liquids with water in a desired concentration while they are being dispensed.

Still a further object of the invention is to improve sanitary conditions and to reduce waste on a kitchen cook line by eliminating the use of bottles and containers as much as possible.

Yet a further object of the invention is to provide a kitchen gun which can dispense a combination of ingredients through the gun corresponding to a particular recipe or portion of a preparation with a single control.

Still other objects and advantages of the invention will, in part, be obvious and apparent from the specification.

The invention accordingly comprises the features of construction, combinations of elements and arrangements of parts and processes which will be exemplified in the constructions and processes as hereinafter set forth, and the scope of the invention will be indicated in the claims.

### BRIEF DESCRIPTION OF THE DRAWINGS

The present invention will be described in more complete detail with frequent reference being made to the figures identified below.

FIG. 1 is a schematic representation of the kitchen gun system of the present invention;

FIG. 2 is a perspective view of the kitchen gun itself; and

FIG. 3 is a schematic representation of a computerized control system for the kitchen gun system.

### DETAILED DESCRIPTION OF THE PREFERRED EMBODIMENT

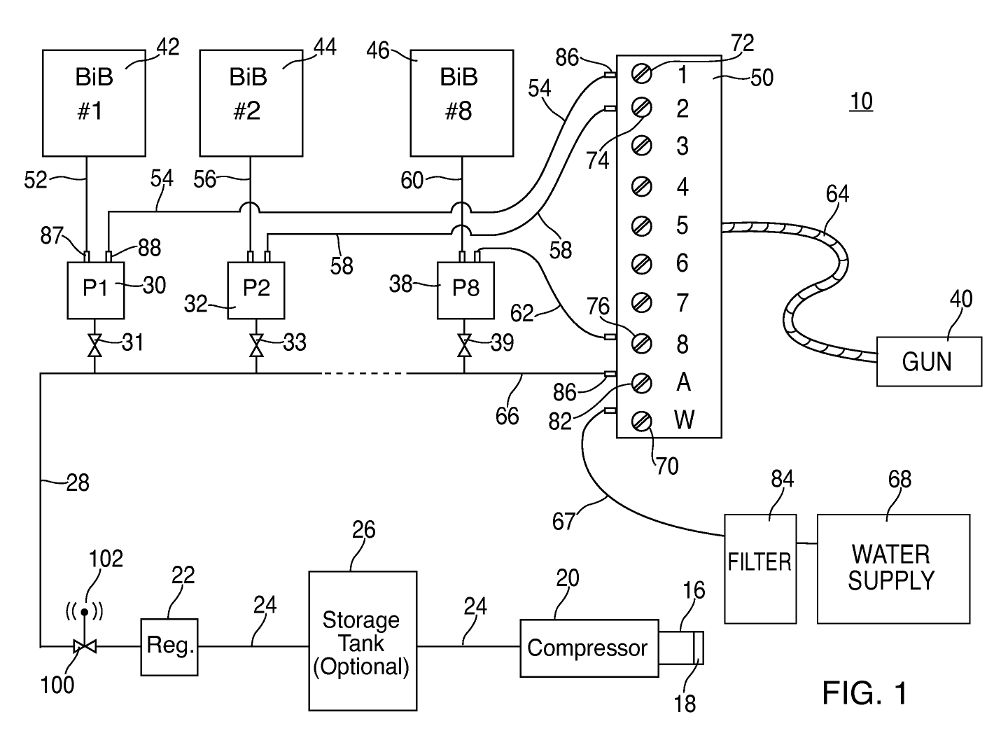

With more specific reference to these figures, FIG. 1 is a schematic representation of the dispensing system or kitchen gun system 10 of the present invention.

The kitchen gun system 10 includes a compressed air means, for example, a compressor 20, such as a Thomas model ultra air T-617 HDN compressor. This compressor has a two-gallon storage tank which may be filled to a pressure of 110 psi. Thomas compressors are manufactured by Gardner Denver Thomas, a division of Gardner Denver Inc. of Quincy, Ill. Compressor 20 has an air intake 16. Filter 18 may be disposed on the air intake 16 to filter particulates and other dust from the air before compression. This is important because compressed air is used to operate the air-driven diaphragm pumps to be described below. Air free of dust and other particulates will extend the useful life of the pumps. Additionally, compressed air itself may be dispensed by the kitchen gun system 10 of the present invention, as will be seen below. It is important that the air be as clean as possible as it may be dispensed in an area where food is being prepared. Suitable filters for air compressors are well known to those of ordinary skill in the art, and are available from many manufacturers.

From compressor 20, compressed air is sent to an air regulating means, such as a a regulator 22, through a hose or hoses 24. The regulator 22 steps the pressure of the compressed air down to a pressure of about 30 psi. The pressure may be increased above this value if there is a long run of tubing between the regulator and the pumps. This (30 psi) is a suitable pressure for operating the air-driven pumps to be described below, as they may not operate below 25 psi. A suitable regulator for use in the practice of the present invention is Regulator Model 5261 SN, which is available from Taprite-Fassco Mfg., Inc. of San Antonio, Tex.

Optionally, a compressed air storage tank 26 may be used to store a larger volume of compressed air than can be accommodated in the relatively small tank provided with the compressor 20. This is particularly useful where the kitchen gun system 10 is to be used in a busy establishment where a large number of meals are prepared each day. Instead of having the compressor cycle on and off repeatedly and frequently to supply air at an appropriate pressure to the regulator 22 in a setting where the kitchen gun system 10 is being heavily used, a larger compressed air storage tank may be more convenient because it would not have to be refilled or recharged by the system as frequently. A suitable tank 26 would be a Spartanburg three-gallon tank (Model 22-29748) available from Spartanburg Stainless Steel Products, Inc. of Spartanburg, S.C. In addition, it should be noted that compressor 20 may be installed at a location remote from the kitchen, so that noise which is produced when it is running will not be heard there.

From regulator 22, hose 28 supplies compressed air to pumps 30, 32, 38, which may be, for example, SHUR-flow Heavy Duty Advantage air-driven diaphragm pumps (Model G55-1022) available from SHUR-flo of Cypress, Calif. In pumps of this kind, a diaphragm, pushed periodically by air at elevated pressure, is used to pump a fluid. Because hose 28 supplies compressed air to pumps 30, 32, 38, if one of the pumps 30, 32, 38 happens to fail, pressure to the remaining pumps may be lost, causing the entire system 10 to fail. To prevent such a complete failure, pumps 30, 32, 38 are provided with shut-off valves 31, 33, 39, respectively, so that the shut-off valve 31, 33, 39 associated with a failed pump may be closed to isolate the failure and to maintain pressure to the rest of the system 10. Without such a means to isolate a failed pump from the system 10, the compressor 20 might run continuously and possibly burn out. Suitable air shut-off valves are well known to those of ordinary skill in the art, and are available from many manufacturers. Alternatively, electrically operated pumps may be used instead of gas-driven pumps; in such a case, the compressed air system described above would not be required to operate the pumps.

For the sake of the present discussion, it is assumed that the kitchen gun system 10 includes eight pumps, although the system 10 could have more or fewer pumps if the situation so required. As a consequence, it should be understood that the presence of eight pumps is primarily for purposes of illustration, and should not be taken to limit the present invention in any way. Moreover, in order to keep FIG. 1 as uncluttered as possible, only three pumps 30, 32, 38 are actually shown.

Regardless of number, each pump 30, 32, 38 may be used to deliver a specific edible liquid ingredient to the kitchen gun 40, a hand-held device used to dispense the ingredient desired. The various edible liquid ingredients are provided in bag-in-box (BiB) packaging for use with the kitchen gun system 10. Essentially, the ingredients are sealed in plastic bags having appropriate outlets for connection to pumping equipment and contained within corrugated boxes to protect them from punctures. The ingredients could be any of a variety of different stocks, sauces, and condiments.

For example, in the discussion above, the preparation of stock from a solid base was described. With the present invention, stock can be provided in the form of a highly concentrated liquid precursor and pumped to the kitchen gun 40 where it will be mixed with an appropriate amount of water, as will be described below, while being dispensed. The mixing of the concentrated liquid precursor and the water is done in the kitchen gun 40 itself, with the ingredients staying in their original form unless and until they are actually dispensed. This reduces almost completely the wasted concentrated liquid precursor and aids with the cleanup, sanitation and efficiency of the system. As a consequence, the preparation of stock for soups, sauces, and the like can be greatly simplified, and enable the cook or chef to make only the quantity of stock needed without cluttering the kitchen cook line with bottles and other containers, and without waste of unused portions.

Many varieties of highly concentrated liquid precursors for stock can be prepared for use with the present invention, for example, chicken, beef, lobster, fish, vegetable, and so forth. Other ingredients that may be provided in the BiB packaging are: condiments, such as mustard, catsup, and mayonnaise; barbeque sauces; soy sauce; olive oil; vegetable oil; lemon juice; cooking wines; and icing. No doubt, many other ingredients will come to the mind of an experienced cook or chef.

Turning back to FIG. 1, let us assume for purposes of illustration that BiB #1 (42) contains highly concentrated liquid precursor for beef stock; that BiB #2 (44) contains red cooking wine; and that BiB #8 (46) contains sesame oil. The first, highly concentrated liquid precursor for beef stock, will be pumped from BiB #1 (42) by pump P1 (30) through hoses 52, 54 to manifold 50. Hose 52 is connected to pump P1 (30) at inlet 87, and hose 54 is connected to pump P1 (30) at outlet 88. In like manner, the red cooking wine will be pumped from BiB #2 (44) by pump P2 (32) through hoses 56, 58 to manifold 50, and the sesame oil will be pumped from BiB #8 (46) by pump P8 (38) through hoses 60, 62 to manifold 50.

Gun 40, which may more broadly be referred to as a dispenser or a hand-held dispensing gun, and manifold 50, connected to one another by hose 64, are available from a variety of sources, such as Automatic Bar Controls, Inc. of Vacaville, Calif. as WUNDER-BAR®. WUNDER-BAR® is a registered trademark owned by Automatic Bar Controls. A suitable gun and manifold can take a variety of forms, and in a current preferred mode would be Model WB 10 JD. As illustrated, the manifold 50 includes ten inputs 86 where hoses from pumps 30, 32, 38 are attached, as well as compressed air hose 66 and a water hose 67 from water supply 68. Each of the inputs 86 has an adjustment means, such as an adjusting screw, which is used to set a valve within the manifold. Various other adjustment means are available to achieve the appropriate blends. Adjusting screw 70 for the water supply 68 would be adjusted first to give a desired flow of water to the gun 40. Subsequently, other adjusting screws are set to mix the ingredients being pumped to the manifold 50 by pumps 30, 32, 38 with the water in a desired concentration. In the situation being illustrated here, it will be recalled, BiB #1 (42) contains highly concentrated liquid precursor for beef stock. Accordingly, adjusting screw 72 will be set to mix the highly concentrated liquid precursor for beef stock with water in a desired concentration. On the other hand, BiB #2 (44) contains red cooking wine, and BiB #8 (46) contains sesame oil, neither of which needs to be mixed with any water. Accordingly, adjusting screws 74, 76 are set so that no water is mixed with these ingredients.

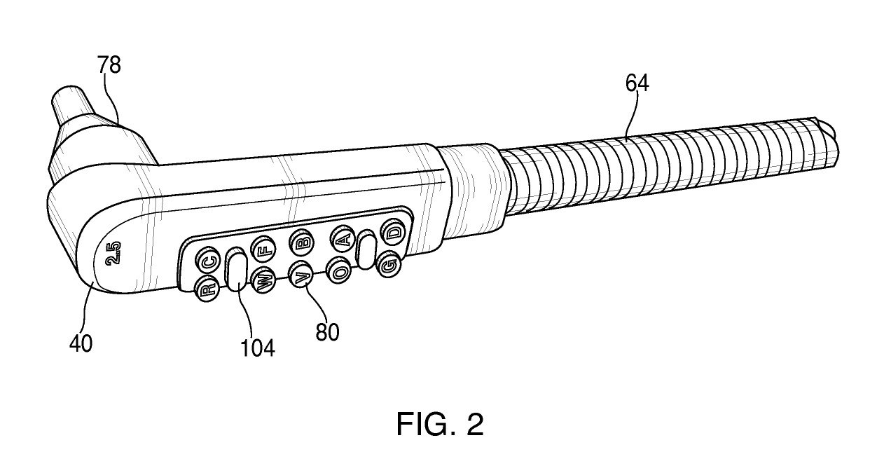

As previously noted, a hose 64 connects the manifold 50 to the kitchen gun 40 itself. FIG. 2 is a perspective view of the kitchen gun 40 and a portion of hose 64 leading therefrom. Hose 64 is covered with food-grade plastic which is easily kept clean in the kitchen. It should be understood that hose 64 actually includes a plurality of hoses at least equal in number to the number of inputs 86 on the manifold 50.

On the kitchen gun 40, it will be noted, are ten round buttons 80 which correspond to the ten inputs 86 on manifold 50. By pressing the appropriate button 80, the chef or cook can obtain stock, red cooking wine, or sesame oil from the gun 40, the liquid precursor of the stock being mixed with water in a desired concentration, and the red cooking wine and sesame oil not being mixed with any water. It will be noted that the gun 40 has an outlet from the form of a mixing funnel 78. In cases where water is being mixed with another ingredient, such as a highly concentrated liquid precursor for a stock, they are mixed in the desired concentration within the mixing funnel 78 before flowing out the bottom.

Two of the buttons 80 are for compressed air and water. Adjusting screw 82, of course, is set so that no water is mixed with the compressed air when the appropriate button is pressed. One might well wonder why compressed air would ever be needed in a kitchen. At present, damp cloths are commonly used to keep the working surfaces of the kitchen cook line clean and free of pieces of food. Unfortunately, these cloths, if not rinsed and kept clean on a regular basis, become breeding grounds for bacteria and contamination. Compressed air, available by pressing the appropriate button on the kitchen gun, is a much more preferable way to keep the working surfaces clean and free of pieces of food by simply blowing the loose material away.

It should also be noted that the kitchen gun itself is easily kept clean by submerging it completely in a cleaning and disinfecting solution, such as a food-quality bleach solution. In this regard, the mixing funnel 78 may be removed from the kitchen gun 40 for thorough cleaning, and then snapped back into place. Mixing funnel 78 is where the water and concentrated liquid precursor mix. Periodically, the entire kitchen gun system 10 may be cleaned by connecting all pumps 30, 32, 38 to a supply of hot water, and by operating the kitchen gun 40 to flush the hot water outward through the entire system. At all other times, the kitchen gun system 10 is sealed, thereby preventing bacteria from gaining a foothold therewithin.

Compressed air hose 66 may convey compressed air from hose 28 on the output side of the regulator 22 to manifold 50. Alternatively, it may be supplied from a source independent of the compressor 20 and regulator 22.

Water supply means, such as water supply 68, may be tap water which is optionally double-filtered to remove impurities. Filter 84 may be used for this purpose. Suitable water filter systems are available from Everpure, LLC of Hanover Park, Ill., and are well known to those of ordinary skill in the art. Clean, filtered water will improve the quality and taste of the food being prepared using the system 10. Alternatively, where the local water conditions are not suitable, a bottled or other pre-packaged water can be used.

Water supply 68 may be that provided from the tap or plumbing of the building in which the kitchen gun system 10 is used. It is well known, however, that the pressure in such a water supply 68 may not be constant due to a variety of factors, such as the intermittent demand for water from other users drawing from the same supply. As a consequence, the pressure of the water supplied to the system 10 may fluctuate.

The result of such fluctuation is that the concentration of stocks and other liquids being mixed with water and delivered from the gun 40 may also fluctuate because the adjusting screws on the manifold 50 are set when the water is at a given pressure. Should the pressure change, and more or less water flows to the gun 40 in a given period of time, the concentration of liquids being mixed with the water will change and will be weaker or stronger than desired. This is not a very desirable situation to be had in a kitchen in a commercial establishment.

This may be addressed by installing a reservoir system as part of water supply 68. The reservoir system includes a tank which is filled with water from the local supply on a constant basis. The tank is closed, so that air may be pumped in as water is removed to keep the pressure at a desired level. As a consequence, the same amount of water will flow from the gun 40 in a given period of time, and concentrations of liquids being mixed with water will remain at desired levels. Suitable reservoir systems are well known to those of ordinary skill in the art, and are available from many manufacturers.

As noted above, one of the edible liquid ingredients that may be dispensed with the present kitchen gun system 10 is icing. A baker in a commercial bakery may thus use the system 10 to decorate cakes and other pastries. In such an application, several different colors of icing may be provided in BiB packaging. At the touch of a button, a pastry chef can then decorate a cake with several different colors of icing in a very short time. Moreover, the mixing funnel 78 may be interchangeable with others having differently shaped openings, so that decorations may be made in a variety of different designs.

In practice, in a commercial kitchen, one or more manifolds 50 may be mounted above the kitchen cook line and their respective gun or guns 40 suspended, like commercial dishwashing hoses, from above the kitchen cook line, where they may be easily reached and pulled down for use when required by a chef or cook. When more than one manifold 50 and gun 40 is to be used, they may all be connected to the same set of pumps and BiB packages.

Moreover, in a commercial kitchen, the kitchen gun system 10, except for the one or more manifolds 50 and guns 40, may be housed in a single cabinet, from which the hoses would run to the manifold or manifolds 50. The cabinet would ordinarily remain closed, except when a BiB package has been emptied and needs to be replaced. As previously noted, the compressor 20 could be kept in a more remote location, so that noise which is produced when it is running will not be heard in the kitchen.

Finally, a portable version of the kitchen gun system 50 also falls within the scope of the present invention. For such a version, the cabinet described in the preceding paragraph may be mounted on a cart or truck which may be readily moved from one location to another, such as to an outdoor banquet or trade show. The compressor 20, optional storage tank 26, regulator 22, and manifold 50 could also be mounted on such a movable structure, so that the gun 40 could be used in a temporary situation.

The kitchen gun system 10 of the present invention can be given the capability to collect a wide variety of data on the use of the system 10 in a kitchen in a commercial establishment. In turn, that data can be mined by the operators of the restaurant or other dining establishment to monitor the use of the system 10 by the chefs or cooks working there for quality control purposes and to eliminate waste.

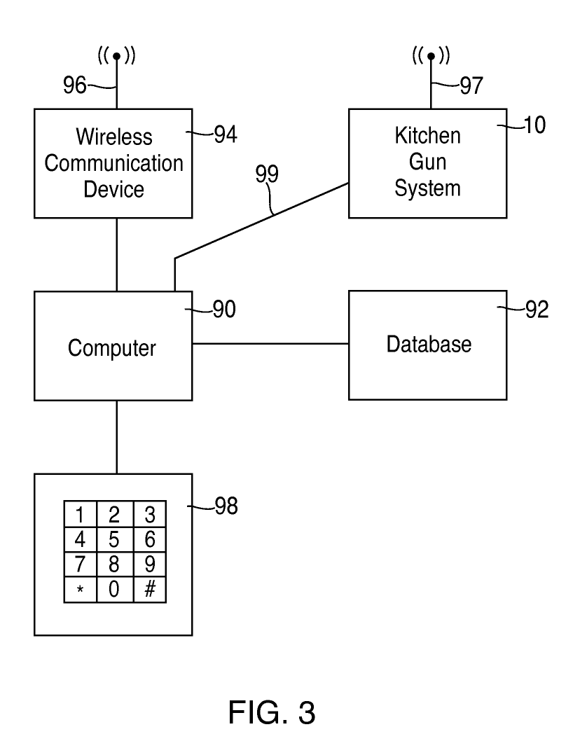

Turning to FIG. 3, a computer 90, programmed to collect data of interest on the use of the system 10 as will be described below, is coupled to a database 92 for the storage of the data. The computer 90 is also connected to a wireless communication device 94 having an antenna 96 to transmit commands from the computer 90 to the system 10 and to receive data from the system 10 for storage in database 92. Also attached to the computer 90 is a keypad 98, by which employees can “log on” to the system 10 using their preselected identification numbers. The kitchen gun system 10 can also have an antenna 97 to connect to the wireless communication device 94. Or, alternatively, the connection can be a hard wired solution 99 where the sensors in the kitchen gun system are directly connected to the computer 90.

The system 10 in this embodiment includes a wireless master shut-off valve 100 having an antenna 102, as shown in FIG. 1. When no one is logged on to the system 10, valve 100 is closed so that compressed air is not provided to the system 10 rendering gun 40 incapable of dispensing any liquid from BiB #1 (42), BiB #2 (44), and BiB #8 (46). The computer 90 may also be programmed to shut the system 10 down after a period of inactivity, such as that which may occur when a chef or cook forgets to “log off” at the end of a business day. It may also be programmed to require the chef or cook to log in again at the time of a shift change so that a new chef or cook needs to log in rather than just continue to use the system 10.

Once a chef or cook logs on, computer 90 sends a signal through wireless communication device 94 to open valve 100, enabling the system 10 to operate. It will be recalled that gun 40 includes in a current preferred embodiment ten round buttons 80 which correspond to the ten inputs on the manifold 50. Gun 40, in this embodiment, is modified to include a wireless relay for each of the buttons 80 and a power supply, such as a battery, to operate the wireless relays. When gun 40 has been so modified, data on the operation of the gun 40 may be sent wirelessly to the computer 90 for storage in the database 92.

More specifically, when a chef logs on to the system 10 using keypad 98, the computer 90 will cause valve 100 to be opened, making the system 10 operable. The date and time the chef logs on will be stored in the database 92. Thereafter, each time the chef presses one of the ten round buttons 80, the time the button 80 was pressed, and the duration of the press, will be recorded in the database 92. The system 10 will have been calibrated during installation and initial set-up, so that the flow rates for the liquids dispensed when each of the buttons 80 is pressed will be set in the computer 90. As a consequence, the amount of the liquid dispensed can be calculated from the duration of the press of button 80 and the result stored in the database 92. Alternatively, a flowmeter can be installed in the gun 40 to measure the flow rates of the liquids as they are dispensed. In this case, the flow rate will be sent wirelessly to the computer 90, along with the time and duration data, and can be used to calculate the amount of the liquid dispensed.

Using the data collected in this manner, management can generate reports on the use of the gun 40 and on the amounts of the liquids dispensed, so that they will know when to reorder fresh supplies thereof and will be able to evaluate the amount of liquid dispensed per use for quality control purposes and for other reasons, such as employee performance tracking.

Alternatively, the kitchen gun system 10 can be programmed to provide only a fixed preselected amount of liquid when a button 80 on the gun 40 is pressed. For example, the system 10 could be programmed to release any amount from 0.5 oz. to 5.0 gal. of the liquid when a button 80 is pressed. To accomplish this, wireless flow controls are installed in the gun 40 so that, when a given button is pressed, computer 90 signals the flow control wirelessly to close when the preprogrammed amount of fluid has been dispensed.

In addition, rectangular buttons 104 on gun 40, as seen in FIG. 2, having wireless relays associated therewith in the gun 40, may be used to deliver a desired mixture of liquids when a particular recipe is to be prepared. For example, for an order of chicken with lemon juice, white wine, and chicken stock, when button 104 has been programmed in the computer 90 to operate the gun 40 to dispense the required amounts of lemon juice, white wine, and chicken stock, the wireless relay associated with button 104, when pressed, will signal computer 90, which, in turn, will signal the wireless controls associated with those liquids to release the required amounts from the gun 40. This embodiment of the kitchen gun system 10 enables recipes for frequently ordered dishes to be more easily prepared.

It will thus be seen that the objects set forth above, among those made apparent in the preceding description, are efficiently obtained, and, since certain changes may be made in the above constructions without departing from the spirit and scope of the invention, it is intended that all matter contained in the above description or shown in the accompanying drawings shall be interpreted as illustrative, and not in a limiting sense.

It is also to be understood that the following claims are intended to cover all of the generic and specific features of the invention herein described and all statements of the scope of the invention, which, as a matter of language, might be said to fall therebetween.

What is claimed is:

1. A dispensing system for dispensing edible liquid ingredients as required, the dispensing system comprising:
a compressed air means for supplying compressed air;
a first hose, having a first end and a plurality of second ends, for receiving compressed air, the first end being coupled to the compressed air means;
a plurality of air-driven pumps, each of the plurality of air-driven pumps being connected to one of the second ends of the first hose, the first hose providing compressed air to each of the plurality of air-driven pumps, each of the plurality of air-driven pumps being powered by the compressed air and having an inlet and an outlet;
a plurality of second hoses, each of the plurality of second hoses having a first end adapted for attachment to a package of an edible liquid ingredient, and a second end attached to the inlet of one of the air-driven pumps;
a manifold for a dispenser, the manifold having a plurality of manifold inputs and a plurality of manifold outputs;
a plurality of third hoses, one end of each of the third hoses being connected to one of the outlets of the plurality of air-driven pumps and the other end of each of the third hoses being connected to one of the plurality of manifold inputs; and
a dispenser, the dispenser being connected to the manifold outputs by a plurality of fourth hoses, the dispenser having a plurality of control mechanisms corresponding to at least the plurality of inputs on the manifold, each of the fourth hoses corresponding to a control mechanism on the dispenser so that selected edible liquid ingredients may be selectively dispensed from the dispenser when desired by operating the respective control mechanisms on the dispenser.

2. The dispensing system of claim 1 further including water supply means for providing water to be dispensed, coupled to one of the manifold inputs by a water hose.

3. The dispensing system of claim 2 wherein the control mechanisms on the dispenser allow one or two of the manifold inputs to flow through to the dispenser when the control mechanism is operated.

4. The dispensing system of claim 3 wherein when the operation of one of the control mechanisms results in two manifold inputs to flow through to the dispenser, one of the manifold inputs will be water.

5. The dispensing system of claim 4 wherein the manifold includes adjustment means for adjusting the relative amount of an edible liquid ingredient to be dispensed along with water.

6. The dispensing system of claim 1 further including air regulating means, the air regulating means being coupled between the compressed air means and the first hose for reducing the pressure produced by the compressed air means to a desired lower pressure.

7. The dispensing system of claim 1 further including a compressed air storage tank, said compressed air storage tank being disposed between the compressed air means and the first hose to store compressed air.

8. The dispensing system of claim 1 further including a master shut-off valve, the master shut-off valve being disposed at a point along the first hose, so that the supply of compressed air to all of the plurality of air-driven pumps may be enabled or disabled, thereby controlling the operation of the entire dispensing system.

9. The dispensing system of claim 1 wherein said compressed air means includes an air intake and a filter on the air intake to filter particulates and other dust from the air prior to compression.

10. The dispensing system of claim 1 further including an air hose, the hose branching from said first hose and connecting to one of the plurality of inputs on said manifold to provide compressed air to said manifold and, when the appropriate control mechanism is operated, to said dispenser.

11. The dispensing system of claim 4 wherein the water and the edible liquid ingredient mix in the dispenser.

12. A dispensing system for dispensing edible liquid ingredients as required, the dispensing system comprising:
a plurality of pumps, each of the pumps having an inlet and an outlet;
a plurality of second hoses, each of the plurality of second hoses having a first end adapted for attachment to a package of an edible liquid ingredient, and a second end attached to the inlet of one of the pumps;
a manifold for a dispenser, the manifold having a plurality of manifold inputs and a plurality of manifold outputs;
a plurality of third hoses, one end of each of the third hoses being connected to one of the outlets of the plurality of pumps and the other end of each of the third hoses being connected to one of the plurality of manifold inputs; and
a dispenser, the dispenser being connected to the manifold outputs by a plurality of fourth hoses, the dispenser having a plurality of control mechanisms corresponding to at least the plurality of inputs on the manifold, each of the fourth hoses corresponding to a control mechanism on the dispenser so that selected edible liquid ingredients may be selectively dispensed from the dispenser when desired by operating the respective control mechanisms on the dispenser.

13. The dispensing system of claim 12 further including water supply means for providing water to be dispensed, coupled to one of the manifold inputs by a water hose.

14. The dispensing system of claim 13 wherein the control mechanisms on the dispenser allow one or two of the manifold inputs to flow through to the dispenser when the control mechanism is operated.

15. The dispensing system of claim 14 wherein when the operation of one of the control mechanisms results in two manifold inputs to flow through to the dispenser, one of the manifold inputs will be water.

16. The dispensing system of claim 15 wherein the manifold includes adjustment means for adjusting the relative amount of an edible liquid ingredient to be dispensed along with water.

17. The dispensing system of claim 16 wherein the water and the edible liquid ingredient mix in the dispenser.

18. A kitchen gun system for dispensing edible liquid ingredients as required for cooking, the kitchen gun system comprising:
a plurality of pumps, each of the pumps having an inlet and an outlet;
a plurality of second hoses, each of the plurality of second hoses having a first end adapted for attachment to a package of an edible liquid ingredient, and a second end attached to the inlet of one of the pumps;
a manifold for a hand held dispensing gun, the manifold having a plurality of manifold inputs and a plurality of manifold outputs;
a plurality of third hoses, one end of each of the third hoses being connected to one of the outlets of the plurality of pumps and the other end of each of the third hoses being connected to one of the plurality of manifold inputs; and
a hand-held dispensing gun, the dispensing gun being connected to the manifold outputs by a plurality of fourth hoses, the dispensing gun having a plurality of control mechanisms corresponding to at least the plurality of inputs on the manifold, each of the fourth hoses corresponding to a control mechanism on the dispensing gun so that selected edible liquid ingredients may be selectively dispensed from the dispensing gun when desired by operating the respective control mechanisms on the dispensing gun.

19. The kitchen gun system of claim 18 further including water supply means for providing water to be dispensed, coupled to one of the manifold inputs by a fifth hose.

20. The kitchen gun system of claim 19 wherein the control mechanisms on the dispenser allow one or two of the manifold inputs to flow through to the dispenser when the control mechanism is operated.

21. The kitchen gun system of claim 20 wherein when the operation of one of the control mechanisms results in two manifold inputs to flow through to the dispenser, one of the manifold inputs will be water.

22. The kitchen gun system of claim 21 wherein the manifold includes adjustment means for adjusting the relative amount of an edible liquid ingredient to be dispensed along with water.

23. The kitchen gun system of claim 22 wherein the water and the edible liquid ingredient mix in the dispenser.

24. The kitchen gun system of claim 18 wherein the fourth hoses are enclosed in a dispensing hose which allows the hand-held dispensing gun to be moved by a user within a range of motion in a work area.

25. The kitchen gun system of claim 18 further including a computerized control system having a computer programmed to collect data on the use of the kitchen gun system.

26. The kitchen gun system of claim 25 wherein the computerized control system is able to disable the operation of the kitchen gun system and enable it when an authorized user logs into the kitchen gun system.

27. The kitchen gun system of claim 25 wherein the computerized control system is able to track the usage of each authorized user and the amount of each of the edible liquid ingredients used by each authorized user.

28. The kitchen gun system of claim 18 wherein the plurality of control mechanisms dispense fixed preselected amounts of each of the edible liquid ingredients.
